(19) United States
(12) Patent Application Publication
(10) Pub. No.: US 2009/0234738 A1
(43) Pub. Date: Sep. 17, 2009

(54) METHOD AND APPARATUS FOR TARGETED ADVERTISING BASED ON VENUE INDENTIFICATION AND EVENT CRITERIA

(76) Inventors: Zachary Edward Britton, Toulomne, CA (US); Derek Stephen Maxson, Twain Harte, CA (US)

Correspondence Address: ROBROY R FAWCETT, 1576 KATELLA WAY, ESCONDIDO, CA, 92027, US

(21) Appl. No.: 12/340,560

(22) Filed: Dec. 19, 2008

Related U.S. Application Data
(60) Provisional application No. 61/069,079, filed on Mar. 11, 2008.

(51) Int. Cl. G06Q 30/00; G06Q 90/00

(52) U.S. Cl. 705/14

(57) ABSTRACT

Disclosed is a method for targeted web advertising. In the method, an advertisement selection request is received. A venue associated with the advertisement selection request is identified based on an Internet Protocol (IP) address associated with the advertisement request. An event at the identified venue is likewise identified based on an event schedule. An advertisement for responding to the advertisement selection request is selected based on an advertisement selection criterion associated with the identified event.

### CROSS-REFERENCE TO RELATED APPLICATION

This application claims the benefit of U.S. Provisional Application No. 61/069,079, filed on Mar. 11, 2008, which application is incorporated herein by reference.

### BACKGROUND OF THE INVENTION

1. Field of the Invention

The present invention relates generally to targeting online web advertising to visitors attending events at venue sites.

2. Description of the Prior Art and Related Information

Many Web sites are financially supported by online advertising. Some Web sites sell their own ads and many use, for at least a portion of their advertising inventory, third party ad sales companies. For ease of reference, both types (those who sell their own ad and those who use third party ad sales companies) may be referred to as Ad Networks (AN).

Industry research has revealed that as much as 83% of all advertisements are served on web sites have little value to advertisers. ANs compete heavily for ad space on the most visited pages on the most visited web sites. Other pages receive Run of Network (RON) advertisements served indiscriminately to all Internet users who visit Web sites. These RON advertisements tend to earn much lower amounts per ad shown than their more targeted counterparts. This targeting can include location, user interests and other profile data.

To increase the value of the ad inventory, ANs have utilized Geolocation data which locates the approximate location of an Internet User (typically limited to zip code, latitude/longitude, city or metropolitan level). This type of Geolocation technology is effective at increasing the revenue on an individual advertising impression by 30% or more.

However, this technology does not provide the ability for advertisers to target Internet users more richly by targeting specific locations of value to advertisers. Further investigation has shown that, while geolocation has been used for the collection of information related to a user's general geographical location, and therein learn what advertisements that user may be interested in, a comprehensive method of targeting based upon behavior indicated by the location of the Internet user is currently limited to broad geographical targeting.

Accordingly, there exists a need for providing targeted advertising based on the identification of a specific venue and event type. The present invention satisfies these needs.

### SUMMARY OF THE INVENTION

An aspect of the present invention may reside in a method for targeted web advertising. In the method, an advertisement selection request is received. A venue associated with the advertisement selection request is identified based on an Internet Protocol (IP) address associated with the advertisement request. An event at the identified venue is likewise identified based on an event schedule. An advertisement for responding to the advertisement selection request is selected based on an advertisement selection criterion associated with the identified event.

In more detailed aspects of the invention, the advertisement selection criteria may include demographic information about persons attending the identified event, such as gender, age, residence, profession, income, shopping preferences, or travel interests. Also, advertisement selection criteria may include the identified event's type, such as convention, concert, or sports.

In other more detailed aspects of the invention, the advertisement may be selected further based on information from a monitoring implement associated with an internet user client, such as a web bug or a cookie.

Another aspect of the invention may reside in an apparatus, for targeted web advertising, including means for receiving an advertisement selection request, means for identifying a venue associated with the advertisement selection request based on an Internet Protocol (IP) address associated with the advertisement request, means for identifying an event at the identified venue based on an event schedule, and means for selecting an advertisement for responding to the advertisement selection request based on at least one advertisement selection criterion associated with the identified event.

Yet another aspect of the present invention may reside in a computer program product comprising computer readable medium including: code for causing a computer to receive a web advertisement selection request, code for causing a computer to identifying a venue associated with the advertisement selection request based on an Internet Protocol (IP) address associated with the advertisement request, code for causing a computer to identify an event at the identified venue based on an event schedule, and code for causing a computer to select an advertisement for responding to the advertisement selection request based on at least one advertisement selection criterion associated with the identified event.

### BRIEF DESCRIPTION OF THE DRAWINGS

The accompanying drawings illustrate embodiments of the present invention and, together with the description, serve to explain the principles of the invention.

FIG. 1 is a table showing a venue targeting database listing venues and corresponding characteristics.

FIG. 2 is a table showing an event targeting database listing events occurring at the venues and corresponding characteristics of the events.

FIG. 3 is a flowchart illustrating a process of importing data from the venue and event databases into an advertising network database.

FIG. 4 is a flowchart illustrating a process of ad insertion using venue and event targeting.

FIG. 5 is a table database of behaviors derived from an analysis of event attendees.

FIG. 6 is a block diagram showing an apparatus for target web advertising, according to the present invention.

FIG. 7 is a flowchart illustrating a method for target web advertising, according to the present invention.

### DETAILED DESCRIPTION

The present invention allows for the use of IP targeting to identify a type of venue such as a hotel, airport or entertainment venue, to classify this venue by its type of value to advertisers, and to classify events held at these venues. This allows advertisements and other web content to be targeted based upon visits to venues and events based on the IP Addresses used at the venues and the dates of specific events.

A database of venues and event locations is developed for use as targeting criteria in the delivery of advertising. For example, as an Internet user visits various airports around the world, information about the user's travel interests may be learned. This type of behavioral analysis could reveal that the user has visited Miami, New York, Denver and Vancouver in the last three months. Advertising targeting business travelers, frequent travelers, ski vacations, cruises or similar products and services could be sent to her. This behavioral interest may not be able to be derived otherwise by a given ad network.

The database may be compiled through any of the following methods: on-site visits made to identify the IP address range identified, use of existing IP address registrations available through Arin (www.arin.net) or other authority, or the venue may provide the information to the database directly. The database should be accurate and current so that the advertising is correctly targeted. The creation of the database and subsequently and use by ANs provides for the targeting of advertising or use by web publishers to direct specific content to the visitor based upon this type of IP targeting.

Venues may be classified by criteria such as venue type, venue name and brand. Each venue may be tagged with demographic information for the average visitor such as age, income, home location, business or shopping preferences or other demographics. These demographics present significant value to the Advertisers because they reveal some of the most valuable and most sought data in a way that is currently unavailable to this extent.

The venue database may be utilized by ANs so that the data becomes useful for targeting advertising according to its value. The mapping interface may link demographic data derived from the database for use in targeting advertisements.

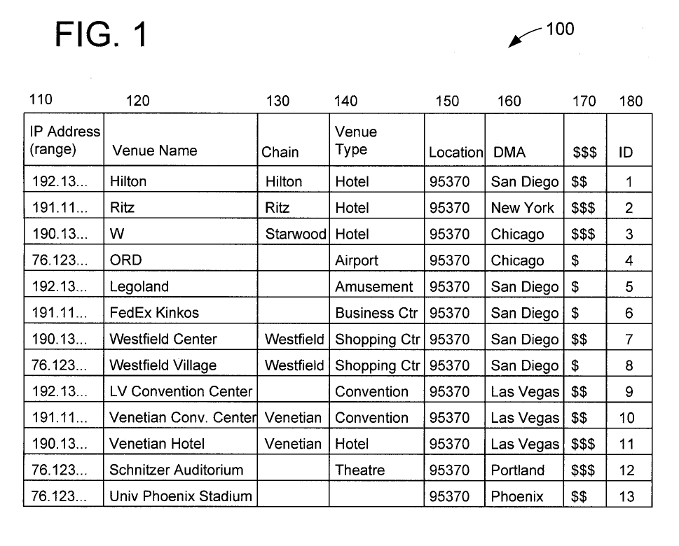

FIG. 1 depicts an exemplary venue targeting database 100 for organizing venues and their characteristics, and storing several criteria. In column 110, the IP Address range(s) of the venue location is stored. The range of IP Addresses shall encompass all the addresses available to visitors to that venue through which they may access the public Internet. The addresses in step 110 shall only be the public, routable addresses and not any addresses known only to a private network using Network Address Translation or a proxy server. In column 120, the name of the Venue shall be stored. This identifies the venue by name and perhaps by location. In column 130, the organization or chain of venues that are jointly owned or operated is indicated. With this criteria, content may be targeted to all visitors to a particular venue organization. In column 140, the venue type is stored. The type field is intended to provide targeting criteria based upon the genre of network. Exemplary venue types include, but are not limited to, hotels, airports, shopping areas, entertainment venues and businesses. In column 150, the location field of the venue is stored. The location is typically identified though a zip code, postal code, or by latitude and longitude. In column 160, the DMA field of the venue is stored. This refers to the Designated Market Area, the common term given to media markets. In column 170, a representation of the costs that a typical customer or visitor to a venue may pay is stored. This value may be stored as a range or an absolute value. In column 180, a record identifier is stored to reference the record in other relational tables in the database.

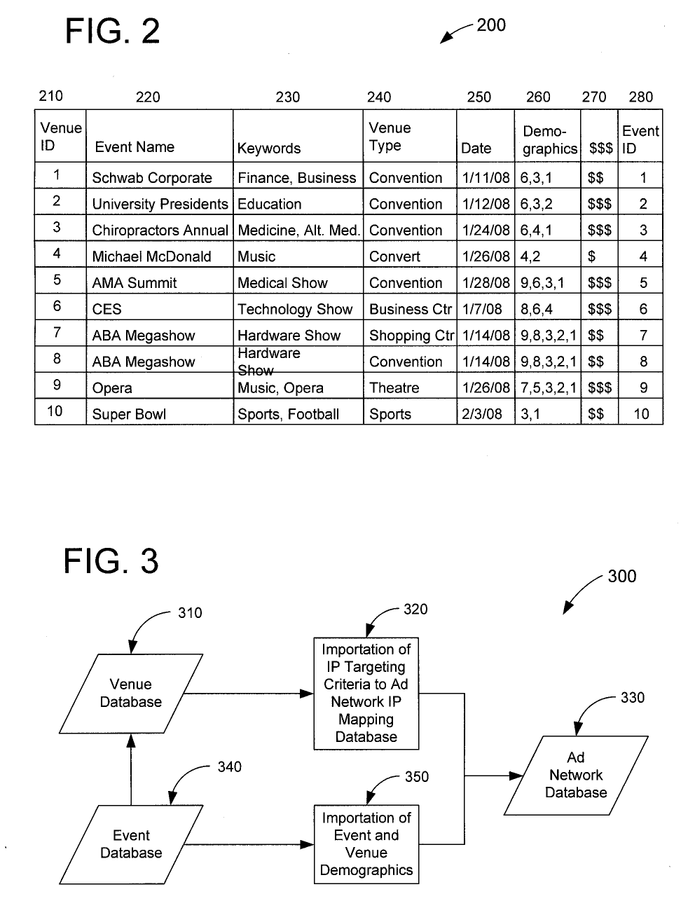

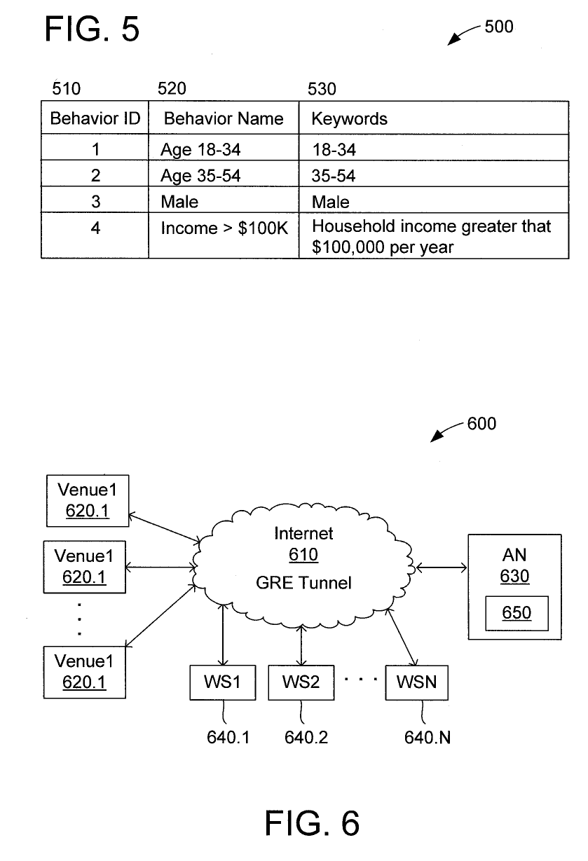

FIG. 2 depicts an exemplary event targeting database for organizing or listing events occurring at the venues as well as the characteristics of these events, and storing several criteria. In column 210, the venue identifier is stored. This value corresponds to a record in column 180 in the venue database shown in FIG. 1. In column 220, the Event name is stored. In column 230, a list of keywords is stored which comprise a definition of attributes about the event and its attendees. These keywords may be used for targeting content to the users who visit the event listed in column 220. In column 240, the event type may be stored. The event type may include descriptive terms such as convention, concert, sports or any other criteria that may be used to target content relevant to the visitors of the venue and its events. In column 250, a date or range of dates that comprise the duration of the event may be stored. In column 260, a series of demographic values that relate to attributes reflecting the attendees of the event may be stored. These demographic values are described in more detail in FIG. 5. In column 270, a representation of the costs that a typical customer or visitor to a venue may pay may be stored. This value may be stored as a range or an absolute value. In column 280, a record identifier is stored to reference the record in other relational tables in the database.

FIG. 3 depicts a flowchart illustrating the process 300 of importing venue database information into an ad network database. The venue database 310 is searched for relevant IP targeting criteria for a given event. At step 320, the IP Targeting criteria for a particular event are imported to the ad network IP mapping database 330. The event database 340 is searched for relevant event criteria, such as times, locations, and dates, and subjects. At step 350, the event and venue demographics are imported to the ad network database 330. The ad network database 330 receives the venue and event information and proceeds to process the data to serve relevant advertisements.

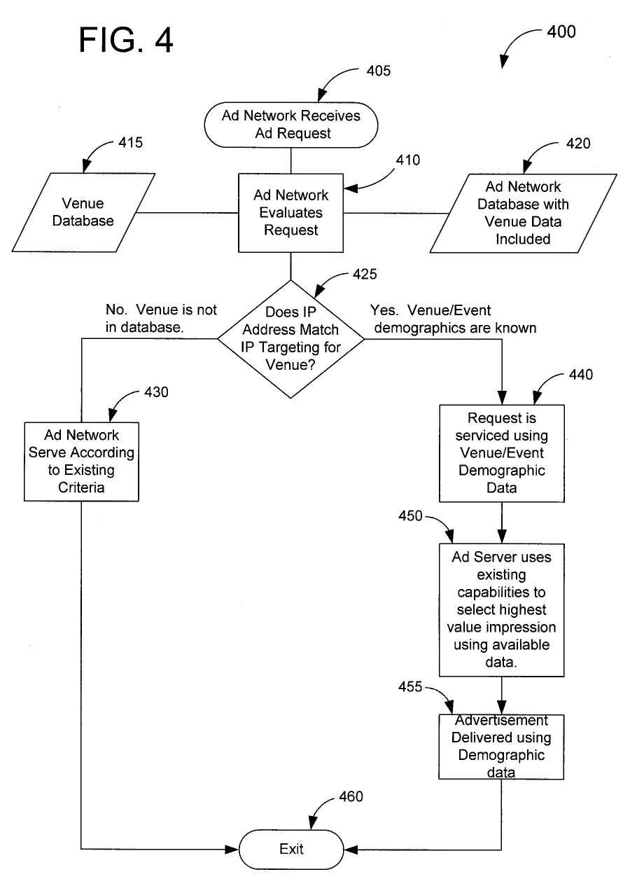

FIG.4 depicts a process 400 of ad insertion using venue and event targeting. At step 405, the ad network receives an ad request for a particular client. At step 410, the ad network evaluates the request by gathering data from databases. At step 415, the ad network queries the venue database for information on the requesting client. At step 420, the ad network queries the ad network database, which includes the venue database information, for information on the requesting client. Step 425 depicts the evaluation logic in handling the ad request. If the client IP address does not match the venue's IP targeting criteria, the process proceeds to step 430. If there is a match of the IP address, the logic proceeds to step 440. At step 430, the ad network serves an ad according to existing criteria and proceeds to step 460. At step 440 the ad network processes the ad request using existing demographic information from the venue database. At step 450, ad servers use their existing methodology to evaluate all available behavioral data and choose the highest value advertisement. The chosen advertisement may or may not be related to behavior generated by venue and event targeting. In many cases, the most valuable advertisement will be chosen using criteria from the present invention's database of venue and event behaviors. At step 455, an ad is served to the requesting client using demographic data. At step 460, the process exits.

FIG. 5 depicts a database of behaviors derived from an analysis of event attendees. In column 510, an identifier of behavior is stored. This value corresponds to a value in FIG. 2, column 260 to easily identify and use the behavioral definitions. In column 520, a name is given to easily identify the behavior. In column 530, a broader definition of the behavior is provided to communicate the definition of the behavior to users of the behaviors in marketing and customizing content to the user.

U.S. Pat. 6,442,577, titled “Method and Apparatus for Dynamically Forming Customized Web Pages for Web Sites”, incorporated herein by reference, discloses the targeting of content according to the source location of the Internet User. Content may be customized based upon the IP Address or other criteria available in the data stream in accordance with a database of Internet users, providers and locations.

Venues may be classified by criteria such as venue type, venue name and brand. Each venue may be tagged with demographic information for the average visitor such as age, income, home location, business or shopping preferences or other demographics. These demographics present significant value to the Advertisers because they reveal some of the most valuable and most sought data in a way that is currently unavailable to this extent.

Increased value may be gained by serving advertisements to visitors, for example, of luxury hotels and resorts. The targeting of content may be according to the originating IP address of the visitor. If a visitor is found to be located at a venue within the Venue Database, the visitor may be tagged within one or more advertising networks with the demographic data of that venue. The present invention allows for the transmission of the criteria via Tracking Pixel, Cookie Modification, Advertisement tag modification, data feed or other method that one skilled in the art may use to integrate 3rd party targeting data for ad serving.

There is great benefit derived when analyzing the location of the visit to determine if that visitor is at a venue that represents a valuable demographic for advertising. Examples of these types of venues would be airports, hotels, shopping sites, sports and entertainment venues, tourist attractions, business sites, business conferences and other similar locations.

There is the possibility of targeting these Internet users so as to deliver advertisements even after the user has left the venue. There is great benefit derived when analyzing the types of events that are attended by Internet visitors. Through this analysis, certain behavioral patterns, interests and demographic assumptions may be determined. An example of event targeting indicates that there is inherent value in serving advertisements to people who visited the concert of a popular music artist. Through knowing that a user visited a venue that was hosting a concert by this artist, valuable marketing information is inferred including musical interests and perhaps indications of gender, age or location of residence—especially when combined with other data.

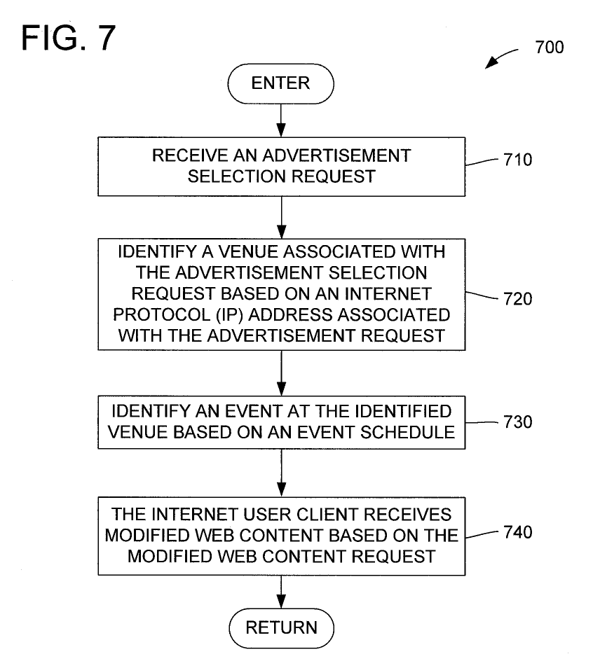

With reference to FIGS. 6 and 7, one aspect of the present invention may reside in a method 800 (FIG. 7) for targeted web advertising. In the method, an advertisement selection request is received (step 710) over the internet 610. A venue 120/620.N associated with the advertisement selection request is identified based on an Internet Protocol (IP) address 110 associated with the advertisement request (step 720). An event 220 at the identified venue is likewise identified based on an event schedule 250. An advertisement for responding to the advertisement selection request is selected based on an advertisement selection criterion, e.g., 230, associated with the identified event.

The advertisement selection criteria may include demographic information about persons attending the identified event, such as gender, age, residence, profession, income, shopping preferences, or travel interests. Also, advertisement selection criteria may include the identified event's type, such as convention, concert, or sports. The selecting of an advertisement may be further based on information from a monitoring implement associated with an internet user client, such as a web bug or a cookie. Techniques related to, and description of, monitoring implements are described in U.S. patent application Ser. No. 11/974,508, which application is incorporated herein by reference.

Another aspect of the invention may reside in an apparatus 600, for targeted web advertising, including means (AN 630) for receiving an advertisement selection request, means for identifying a venue associated with the advertisement selection request based on an Internet Protocol (IP) address associated with the advertisement request, means for identifying an event at the identified venue based on an event schedule, and means for selecting an advertisement for responding to the advertisement selection request based on at least one advertisement selection criterion associated with the identified event. The advertisement may be provided by ad servers or web servers WS 640.N.

Yet another aspect of the present invention may reside in a computer program product comprising computer readable medium (such as a memory device 650 or hard drive) including: code for causing a computer to receive a web advertisement selection request, code for causing a computer to identifying a venue associated with the advertisement selection request based on an Internet Protocol (IP) address associated with the advertisement request, code for causing a computer to identify an event at the identified venue based on an event schedule, and code for causing a computer to select an advertisement for responding to the advertisement selection request based on at least one advertisement selection criterion associated with the identified event.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for targeted web advertising, comprising:
receiving an advertisement selection request;
identifying a venue associated with the advertisement selection request based on an Internet Protocol (IP) address associated with the advertisement request;
identifying an event at the identified venue based on an event schedule; and
selecting an advertisement for responding to the advertisement selection request based on at least one advertisement selection criterion associated with the identified event.

2. A method for targeted web advertising as defined in claim 1, wherein the at least one advertisement selection criterion includes demographic information about persons attending the identified event.

3. A method for targeted web advertising as defined in claim 2, wherein the demographic information includes at least one of gender, age, residence, profession, income, shopping preferences or travel interests.

4. A method for targeted web advertising as defined in claim 1, wherein the at least one advertisement selection criterion includes the identified event's type.

5. A method for targeted web advertising as defined in claim 4, wherein the identified event's type includes at least one of convention, concert, or sports.

6. A method for targeted web advertising as defined in claim 1, wherein selecting an advertisement is further based on information from a monitoring implement associated with an internet user client.

7. A method for targeted web advertising as defined in claim 6, wherein the monitoring implement comprises a web bug.

8. A method for targeted web advertising as defined in claim 6, wherein the monitoring implement comprises a cookie.

9. Apparatus for targeted web advertising, comprising:
means for receiving an advertisement selection request;
means for identifying a venue associated with the advertisement selection request based on an Internet Protocol (IP) address associated with the advertisement request;
means for identifying an event at the identified venue based on an event schedule; and
means for selecting an advertisement for responding to the advertisement selection request based on at least one advertisement selection criterion associated with the identified event.

10. Apparatus for targeted web advertising as defined in claim 9, wherein the at least one advertisement selection criterion includes demographic information about persons attending the identified event.

11. Apparatus for targeted web advertising as defined in claim 10, wherein the demographic information includes at least one of gender, age, residence, profession, income, shopping preferences or travel interests.

12. Apparatus for targeted web advertising as defined in claim 9, wherein the at least one advertisement selection criterion includes the identified event's type.

13. Apparatus for targeted web advertising as defined in claim 12, wherein the identified event's type includes at least one of convention, concert, or sports.

14. A computer program product, comprising:
computer readable medium including:
code for causing a computer to receive a web advertisement selection request;
code for causing a computer to identifying a venue associated with the advertisement selection request based on an Internet Protocol (IP) address associated with the advertisement request;
code for causing a computer to identify an event at the identified venue based on an event schedule
code for causing a computer to select an advertisement for responding to the advertisement selection request based on at least one advertisement selection criterion associated with the identified event.

15. A computer program product as defined in claim 14, wherein the at least one advertisement selection criterion includes demographic information about persons attending the identified event.

16. A computer program product as defined in claim 15, wherein the demographic information includes at least one of gender, age, residence, profession, income, shopping preferences or travel interests.

17. A computer program product as defined in claim 14, wherein the at least one advertisement selection criterion includes the identified event's type.

18. A computer program product as defined in claim 17, wherein the identified event's type includes at least one of convention, concert, or sports.
